(19) United States
(12) Patent Application Publication
(10) Pub. No.: US 2009/0119001 A1
(43) Pub. Date: May 7, 2009

(54) Method and system for finding multimodal transit route directions based on user preferred transport modes

(75) Inventors: Roy Moussaeiff, Jamaica, NY (US); Marc Sellouk, North Woodmere, NY (US)

Correspondence Address: Feldman Law Group, P.C., 12 East 41st Street, New York, NY, 10017, US

(73) Assignee: PUBLIC ROUTES. COM, LLC

(21) Appl. No.: 11/983,181

(22) Filed: Nov. 7, 2007

(51) Int. Cl. G01C 21/00; G06F 17/30; G06F 7/06

(52) U.S. Cl. 701/200; 707/4; 707/E17.018; 707/E17.014

(57) ABSTRACT

A method and system for finding multimodal transit route solutions with a computer software program is described that finds the most efficient transit routes based on user preferred modes of transport. The route finding system has four layers that include a presentation layer, an application layer, a component layer and a database layer. The system input includes a start address, a destination address and preferred mode of transport to find the most efficient transit routes. The transport mode includes public transport, private transport and combination of public and private transports. The system displays the detailed mapped route directions for the user input. The system also includes tools for location based address finder and local guidance.

### FIELD OF THE INVENTION

The invention relates to a method and a system for finding travel directions, and more particularly to a method and a system having a database for finding transit route directions between a starting point and a destination point based on user preferences indicating a user's preferred multimodal transport combination.

### DESCRIPTION OF THE RELATED ART

Attempts have been made in the art to model route finding systems that suggest efficient travel routes for intra-city and intercity transport. An input to the route finding system generally includes a start point and a destination point. These systems generally recommend a transit route that is a shortest route coverable in shortest time. These systems are generally uni-modal transit systems, using a single means and medium of transportation, such as an automobile traveling on public roads and highways. The uni-modal transit systems in the prior art mainly assume a private vehicle as a mode of transport to find an efficient route.

However, the routes suggested by the systems in the prior art are not necessarily the shortest and most cost effective routes. The travelers may need to use various modes of transport in combination, for example, private vehicle, walking, bus, railway, taxi and/or different combinations of these and other modes of transport.

Moreover, identifying the most efficient route is frequently unattainable when the traveler is limited to a single mode of transport. This is especially true when the path of travel includes both rural and dense city travel, or long intercontinental or cross-country travel book-ended by dense city travel.

Therefore, the inability of electronic travel route finding methods and systems in the prior art to suggest the most efficient travel route (i.e., using multiple modes of transport in combination) may result in many users being dissatisfied with the prior art methods and systems. For example, the travelers may find it difficult to manually search each mode of transport and decide the most efficient route, having to manually choose between the different combinations of the various modes of transport available, and having to employ several different complex route finding methods and travel systems, depending on the number of modes of transport involved in the travel.

Route selection through the prior art becomes even more complex for a prudent cost-conscious traveler. If such a frugal traveler has only tentatively decided on a preferred route for a journey, the traveler may then want to manually compare the financial and time cost using different transportation modes on the pre-decided route. For example, a traveler who has tentatively decided on a route for a journey from a starting point to a destination using a route finding system, then may want to compare the travel benefits and costs using, for example, a private car and a railway, before finalizing the mode of transport. The route advising systems in the art are unable to compare a journey with different modes of transport or a combination of different modes of transport.

Therefore, there is need for a multimodal route finding method and system that advises a traveler (a.k.a., the method and system user) on the most efficient and desirable route from the subjective perspective of the user. I.e., a multimodal route finding method and system that is capable of considering different combinations of various modes of transport, processes weighted selection criteria based on user preferences obtained directly from user input and/or through electronically stored user profile information, and that can compare the travel needs of the user with different modes of transport and with the user's travel preferences in mind.

### SUMMARY OF THE INVENTION

The present invention is directed to a method and a system for finding route directions based on user preference criteria, including preferred modes of transport. The modes of transport are preferably public transport, private transport or combination of public and private transport. The route finding system of the present invention is based on a network of electronic computing devices, which may include, without limitation, desktop and notebook personal computers, servers, telecommunications equipment, personal digital assistants (PDAs), public and private kiosks with electronic processors, memory, and interfaces capable of receiving and storing into memory route finding instructions and user preferences and selections. When these instructions in memory are executed, the system suggests mapped route directions based on user input and selected preference criteria, such as financial and time cost, as well as, modes of transport.

The route finding system of the present invention preferably has a four-tier architecture having a presentation layer, an application layer, a component layer and a data source layer.

The presentation layer provides an interface to the users to input queries and to display information, selection criteria, and the desired route directions. Preferably, the interface can be achieved through certain electronic systems, including without limitation, wired, wireless, and/or fiber optic systems featuring computer equipment, information technology equipment and wired and wireless fixed and mobile telecommunications equipment. Certain mobile telephones, wireline telephones, computer desktops, laptops, kiosks, and PDAs are a few examples of the many interfaces that are suitable to accessing the route finding system and initiating the steps of the route finding method.

The application layer has business logic and transmits data from the data source layer to presentation layer through the component layer. The application layer has tools for mapping locations and finding travel directions using geographic locations, addresses, , a location based address finder and other tools for mapping locations and finding travel directions.

The component layer includes a route finding algorithm, a geocoder, a mapping program, a routing program and a Global Positioning System (GPS). The route finding algorithm is the core software program written to effectively provide point-to-point directions based on user selections and/or preferences, cost information (such as route, financial, and time cost), schedules and artificial intelligence.

The data sources include Point of Interests, Street Data, Transport Modes, and live feeds of updated travel service data such as updated schedules and traffic alerts for particular modes of transport. The database preferably has a plurality of route information that satisfies the different criterion of the route finding algorithm, including, without limitation, shortest route, minimum cost, and the most direct route for each mode of transport.

A software program finds route directions as per user preference information. The user information is obtained at various program “control” points during the execution of the software program. The user can either input the information each time a route search is desired or store user preferences as retrievable user profile information. Initially, the user is directed to select a country from a predetermined list of locations. In the next step the user is directed to select a location from a list of locations in the country. The start address and the destination address are entered simultaneously or subsequently. Address entry includes inputting street details, city and or zip code. The user then selects a mode of transport from a list of modes available. The list includes a plurality of modes of public transport, private transport and combinations of public and private transports that includes walking, train, bus, subway, air train, ferry, subway and walk, bus and train, train and taxi etc.

In the next step the addresses of the starting location and the destination are verified. If the addresses are correct then the control moves to the next step. Otherwise, the program requests the user to correct the address in case of an incorrect address. The control doesn't move to the next step until the addresses are verified with the addresses with the database.

Once the address is verified, in the next step, the program searches the database for the most efficient route per the user preference in the next step. Then the program suggests the most efficient route, and provides mapped route directions. The user has an option to either accept the selection, in which case the control moves to the next step, or to loop control back to the aforementioned step of the selecting a mode of transport for getting alternative route directions using an alternative mode of transport.

A comprehensive database is prepared by collecting the transit information from at least three sources, such as street data providers, transit information agencies and points of interest data providers. The data from these sources is interpreted and preferably converted to a local coordinate system.

In addition to private automobile transport mode options, the database advantageously contains information about a plurality of other transport mode options including, without limitation, railway, bus, taxi, and air modes of transport. This information includes, without limitation, transit schedules, distances, fares, stations, and time information that support the selection of the most efficient transit route. The database of the public route direction finding system is preferably updated at frequent intervals on a regular basis.

A search engine controlled by a software program is based on a predefined searching algorithm that sifts through the database to find the most relevant matches to a search and ranks the matches in order of relevance. The search engine also limits a search area geographically, for a faster search. The searching algorithm of the preferred embodiment has at least four main criteria that includes, without limitation, user selection, route cost, schedules and artificial intelligence.

Preferably, the algorithm first searches according to the user selections preferences, such as, walking, transit modes, locations, mobility requirements and time. The search engine also considers the route cost. A route is discarded over another route if the first route exceeds a predetermined cost.

The searching algorithm also considers schedules of the travel. The schedules stored in the database are preferably refreshed frequently to reflect updated traffic conditions and scheduling for each mode of transport. The searching algorithm also utilizes artificial intelligence while finding route directions. The algorithm is preferably directed by artificial intelligence.

The route directions and the related maps are preferably displayed by two methods. The first method of display is preferably employed where the suggested route includes public transports, for example, railway or bus. The second method of display of maps is employed where private transport, for example, a private taxi or a personal car, is preferred over public transport.

The route finding system of the present invention has a traffic alert system, a location based address finder and a local guidance tool. The location based address finder advantageously maps an address in the coverage area and displays the mapped location. The address finder also displays nearby points of interest such as bus stops, train stations and subway stations, if desired. The local guide tool gives details of local interests or business in a coverage area. The local guide searches local interests, business, facilities and other points of interest in a city using a description of the interest and name of city or zip code of the city.

These and other features, aspects, and advantages of the present invention will become better understood with reference to the following description and appended claims.

### BRIEF DESCRIPTION OF THE DRAWINGS

FIG. 1 is an exemplary technical architecture of route finding system of the present invention,

FIG. 2 is a flow chart that shows steps involved in a method of finding route directions exemplary of with the present invention,

FIGS. 3a and 3b shows a block diagram that shows steps involved in the creation of a route database exemplary of the present invention,

FIG. 4 shows a search engine process diagram for finding efficient multimodal transit routes exemplary of the present invention,

FIG. 5 shows an exemplary graphical user interface for entering input information for find route directions in accordance with a route finding system of FIG. 1,

FIG. 6 shows exemplary graphical user interface that shows the output of the route finding system of FIG. 1, and

FIG. 7 shows an example to demonstrate a first method and a second method of route display in accordance with the present invention.

### DETAILED DESCRIPTION OF THE PREFERRED EMBODIMENT

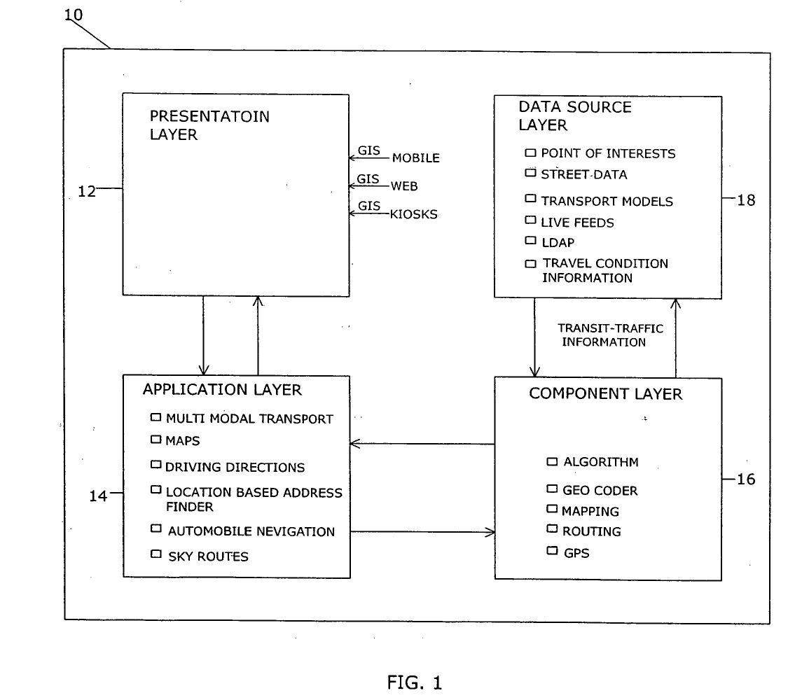

Referring initially to FIG. 1, a block diagram 10 of an exemplary architecture of the route finding system of the present invention is shown. The system preferably has a four-tier architecture, supported by software and hardware systems that can include centralized computer-based and communications-based hardware systems or a distributed network of such systems. The four-tier architecture includes a presentation layer 12, an application layer 14, a components layer 16 and a data sources layer 18. The presentation layer 12 provides the user interface. The application layer 14 imparts problem solving ability to the system. The component layer 16 includes software programs that calculate and analyze data from a plurality of sources. The data source layer 18 stores and manages data for finding efficient multimodal routes.

The presentation layer 12 provides an interface to the users to input queries and user preferences, and also to display the desired route directions. The presentation layer 12 enables data visualization, data manipulation and data entry. The end user views information through a suitable interface. Preferably, suitable interfaces can be achieved through a wide variety of electronic systems, including without limitation, computer equipment, information technology equipment, and wired and wireless fixed and mobile telecommunications equipment. Cellular or mobile telephones, wireline telephones, computer desktops, laptops, hand-held computers, information kiosks, PDAs are but a few examples of such suitable interfaces. The inputs, including user preferences and selections, are provided to the system through such suitable interfaces, the inputs are processed through the route finding algorithm and the output is displayed to the users through the same interfaces.

The application layer 14 has business logic that receives data from presentation layer 12 and connects and queries the data source layer 18 through the components layer 16. The application layer 14 is also responsible for transmitting data from the data source layer 18 to the presentation layer 12 through the components layer 16.

The applications layer 14 has tools that are developed to address various requirements of the users. Preferably, the tools include a map locations tool, driving directions tool, location based address finder tool, automobile navigation tool and sky routes tool. The user queries the data source layer 18 with the tools in the applications layer 14.

The component layer 16 preferably includes discrete building blocks that connect to data source layer 18 to retrieve or save data. The components 16 include route finding algorithm, geocoder, mapping program, routing program and GPS components. The algorithm is the core software program written to effectively provide point-to-point directions based on user selections, route cost, schedules and artificial intelligence. The geocoder is generally a piece of software that assigns geographic coordinates in latitude and longitude to a plurality of locations. With geographic coordinates assigned, the features are mapped and entered into a Geographic Information System. GIS is a useful tool for map making and land surveying.

Data source layer 18 includes various formats of data, stored in at least one database, but more likely, various geographically distributed databases, to feed into the component layers. The data source or sources advantageously include a plethora of Points of Interest, Street Data, Transport Modes, live feeds of up-to-date service schedules and traffic alerts. Preferably, lightweight directory access protocol (LDAP), a well-known Internet Protocol, could be used to look up information and data stored on servers.

The data source layer 18 preferably has a plurality of efficient multimodal routes data that satisfy the different criteria of the algorithm, for example, shortest route and minimum cost data. Preferably, data formats are updated based on a predefined schedule. The live feeds provide real time information to keep the system database up-to-date. The live feeds include information regarding the status of road traffic, accidents, planned and/or unplanned maintenance of roads, weather changes, ground and air mass transit schedules, and other information.

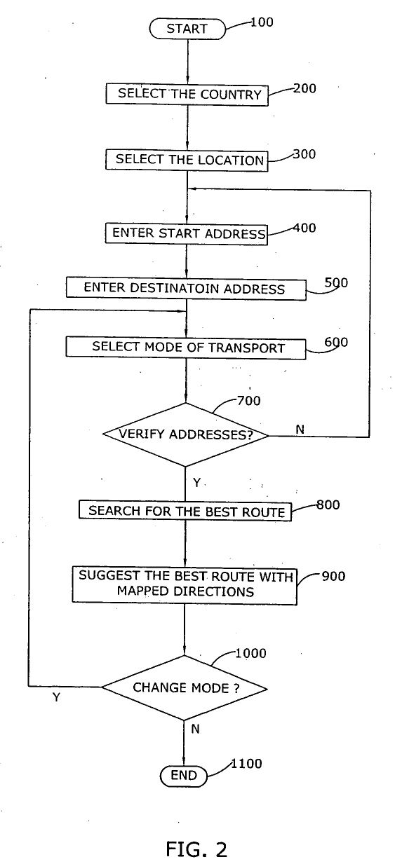

Referring to FIG. 2, FIG. 2 exemplifies the steps involved, preferably, to obtain the efficient multimodal route with a computer software program that receives user input and preferences. The program starts with step 100. Then the program moves to step 200, in which a user is directed to select a country from a predetermined list of countries. In step 300, the user is directed to select a location from a list of locations within the country. In step 400, a start address is entered that includes inputting, for example, street, city and or zip code details. In step 500, the destination address is entered that also includes inputting street, city and or zip code details. The start address and the destination addresses preferably refer to a station, a stop, a point of interest, a street or an intersection point.

In the step 600, the user selects a mode of transport from a list of modes available. The list includes a plurality of modes of public and private transport, as well as, a plurality of combinations of public and private modes of transports. For example, available modes may include: driving, walking, bus, subway, train, bus+subway, bus+train, subway+train and subway+airplane. Different modes are preferably suggested in the multimodal transit system of the preferred embodiment. If the user ignores the selection of the mode of transport, then the system preferably searches for the most efficient transit route, taking into consideration the available modes of transport.

The most efficient transit route, taking into consideration the available modes of transport, is preferably an optimal overall route and mode solution where the distance between the starting address and the destination is coverable in a shortest time, lowest cost and with minimum modes of transport. The software program of the preferred embodiment preferably recommends at least one mode of transport when suggesting an efficient transit route. The recommended route is then changeable by changing the mode of transport, selectable from a list of a plurality of modes of transports.

The addresses of the starting location and the destination are verified in the step 700. If the addresses are correct then the control moves to the next step 800. If any one of the start address and destination address cannot be confirmed with the addresses in the database, then the user is requested to correct the unconfirmed address. The control is transferred back to the step 400, to verify the addresses once again. The step 700 is carried out until verification of both the start and destination addresses is successful.

In step 800, the program searches for an efficient multimodal route with a search engine as per user input and preference criteria. The system suggests an efficient route in the next step 900. At least one or more maps of the suggested route direction are also displayed on the computer monitor in this step. In the step 1000, the user has an option to change the mode of transport for getting alternative route directions using that particular mode.

If the user wishes to change the mode of transport, then the control is transferred to the step 600. The program again passes through steps 600 to 1000. A transit route is recommended with the mapped directions using the new mode selected by the user. The user is once again free to get route directions with another mode of transport. If the user is not interested to get another route direction by changing the mode of transport then the control goes to the next step. The program ends in step 1100.

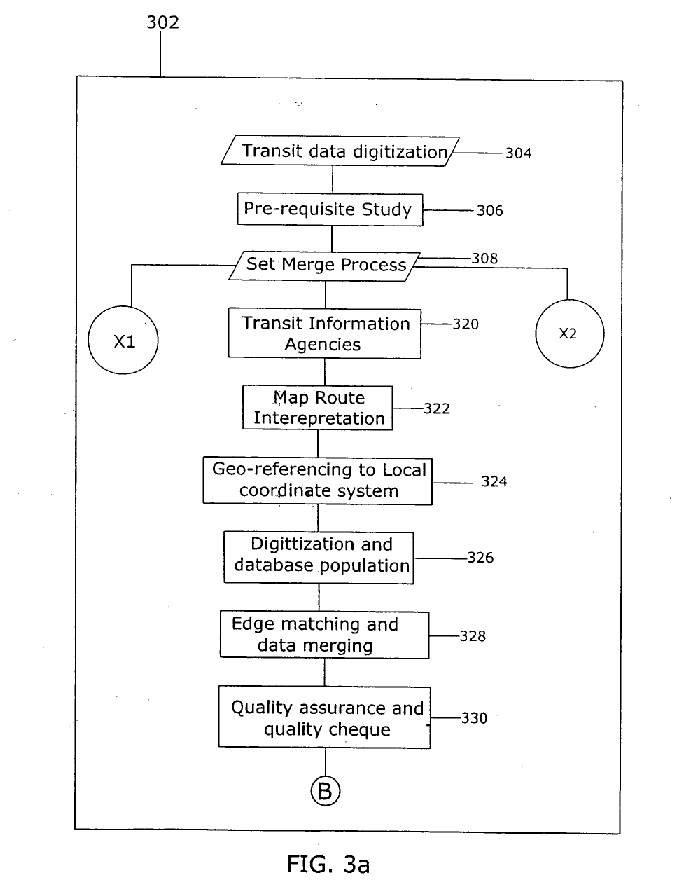

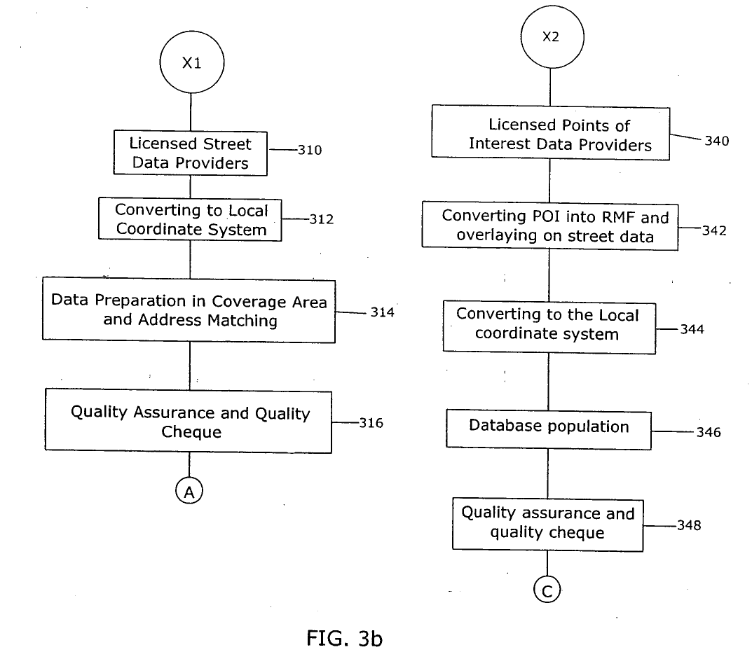

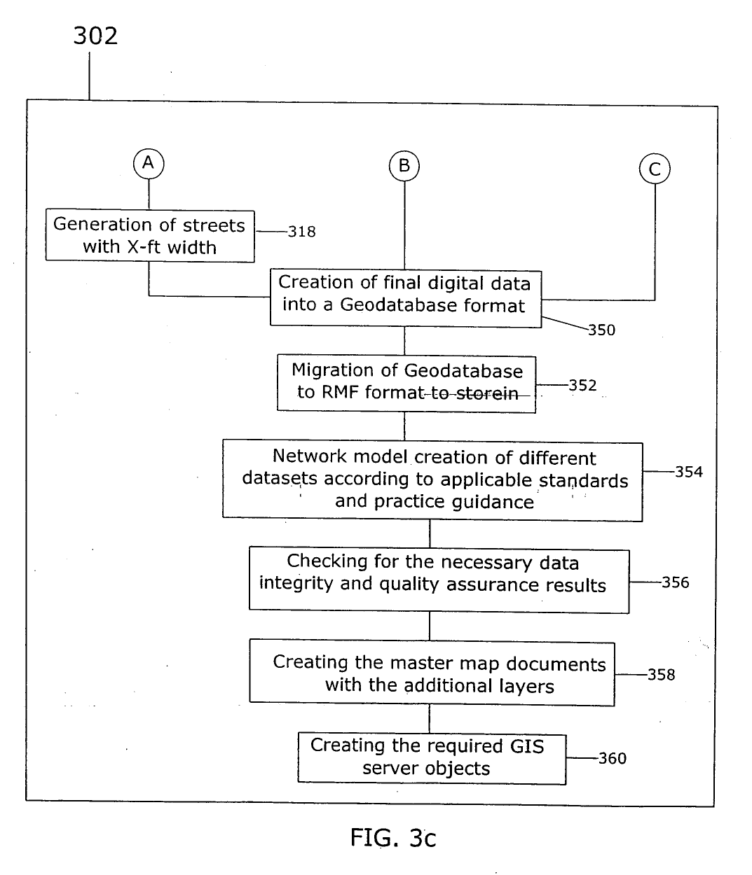

Referring to the FIG. 3a-3b, the steps involved in a method for creation of a compressive transit database 302 are shown. The method begins with transit data digitization 304 and a pre-requisite study 306 in preparation for a set merge process 308. The transit information is preferably collected from at least three sources such as a street data provider 310, transit information agencies 320 and point of interest data provider 340. The data from these sources is interpreted and processed such that the set merge process 308 results in the creation of final digital data into a geodatabase format 350, through three sub-processes, which are discussed in the following paragraphs.

Preferably, data from the street data provider 310 is processed in a series of steps: (1) converting the data to a local coordinate system 312; (2) data preparation in coverage area and address mapping 314; quality assurance and quality cheque 316 are performed; and the data generation of streets 318 is performed.

Preferably, data from the transit information agencies 320 is processed in a series of steps: (1) map route interpretation 322; (2) geo-referencing to a local coordinate system 324; (3) digitization and database population 326; (4) edge matching and data merging 328; and (5) quality assurance and quality cheque 330.

Preferably, data from the licensed points of interest data providers 340 is processed in a series of steps: (1) Converting Points of Interest (POI) into required Rich Map Format (RMF) and overlaying the RMF on the street data 342; (2) converting to a local coordinate system 344; (3) digitization and database population 346; and (4) quality assurance and quality cheque 348.

Once the set merge process 308 results in the creation of final digital data into a geodatabase format 350, the data in the geodatabase format 350 is further processed in a series of steps: (1) migration of geodatabase to RMF 352; (2) network model creation of different datasets according to the guidance provided in applicable local, national and international methods, standards and practices, including, without limitation, public transit website design standards for intelligent transport service and according to other applicable transit service guidance 354 (e.g., as an example of national guidance, the United States Department of Transportation Intelligent Transport Service Guidelines are useful to the development of public transit websites accessed by desktop and notebook personal computers in the United States (http://www.its.dot.gov/transit_dev/guidelines/TAWSUG1.htm)); (3) checking for the necessary data integrity and quality assurance results 356; (4) creating the master map documents with the additional layers (e.g., layers of additional information, including without limitation, public transit routes, stations, stops, transfer points, points of interest may be compressed into one layer forming a master document map) 358; and (5) creating the required GIS objects 360.

The data of each of the sources passes through a quality check. A digital data outfit in a Geo-database format is then created form all the data sources. The Geo-database is preferably migrated into a rendering mechanism and format, such as RMF, for secured storing. A master map document is then prepared from the additional layers of data. Then the required GIS server objects are created from the master map.

The transit database advantageously includes information of a plurality of transport modes such as railway, bus, taxi and other public and private modes of transport. This information includes transit schedules, distances, fares, stations, and duration of travel time and other information that supports the selection of efficient transit routes based on user input preferences and selections. The transit database is preferably updated at frequent intervals on regular basis.

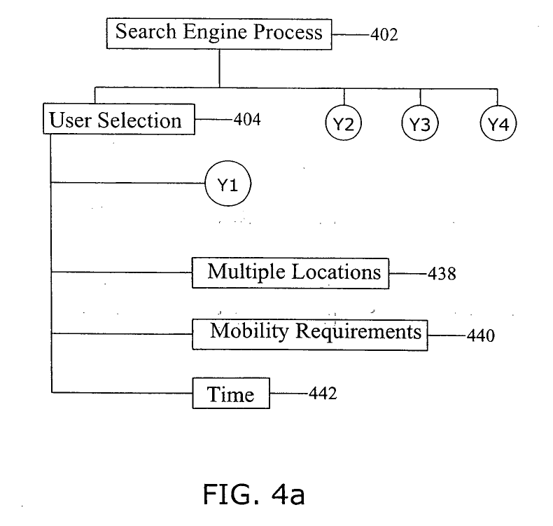

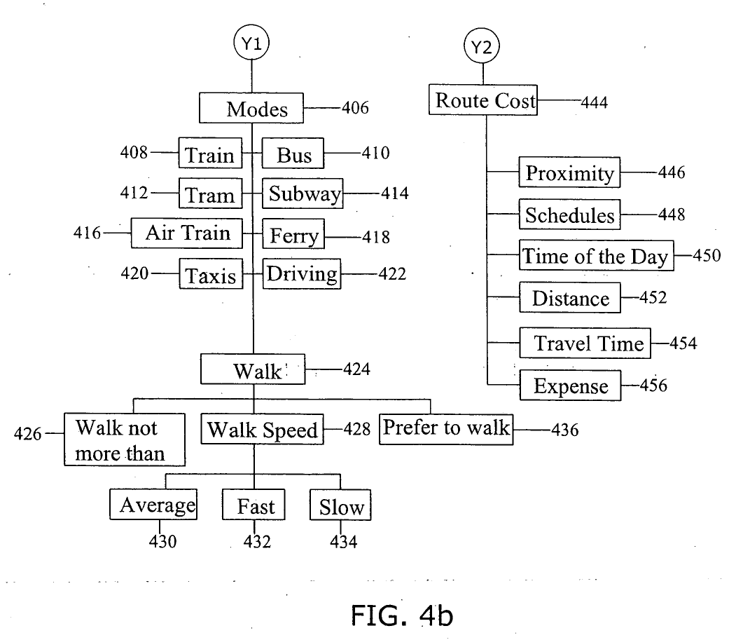

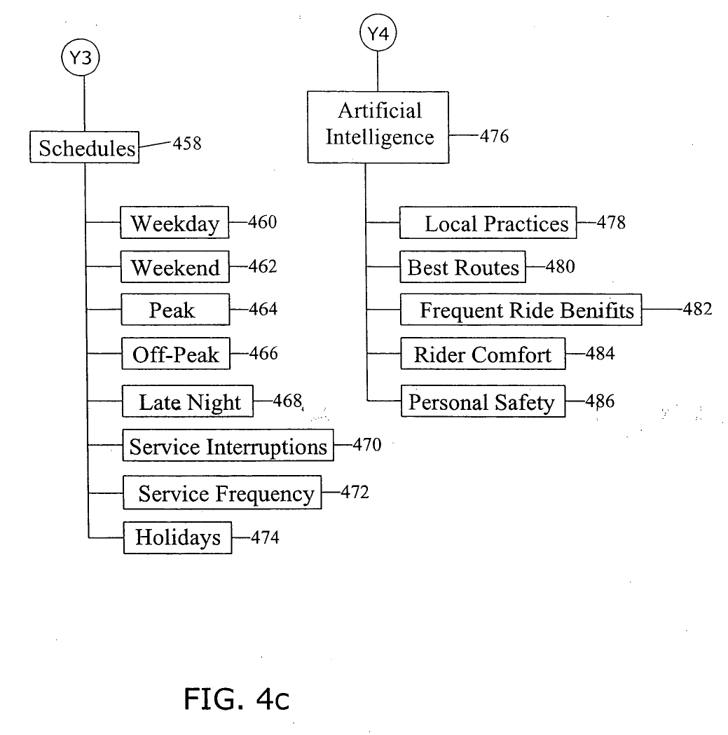

Referring to FIG. 4, a search engine process 402 is a software program based on a predefined searching algorithm that sifts through the transit database to find most relevant matches to a search and rank the matches in order of relevance. The search engine also uses techniques of limiting a search area for a faster search.

When a user chooses a particular Mode of Transport 406 from one of the User Selection 404 options, the search engine populates all modes of transport within a certain radius from the start address to detect a first point of interest.

If there are no modes of public transport available in the certain radius, the search engine expands the search radius until a mode public of transport is found. Preferably, the first point of interest is a public transport mode that is nearest from the start address (e.g., a train station or a bus stop). In the event, the search engine finds two or more such stations or stops, the search engine then selects the mode of transport nearest to the start address.

The search engine then finds nearest stations/stops to the destination address to select a second point of interest. The second point of interest is a station or a stop of public transport mode that is nearest from the destination address. The search engine then finds matching routes between first point of interest and second point of interest. To find the matching routes, the search engine has at least four criterions that include, without limitation, user selection, route cost, schedules and artificial intelligence.

The user selection is a first criterion of the searching algorithm. The algorithm first searches according to the user preferences, such as, available modes of transport 406 including, without limitation, train 408, bus 410, tram 412, subway 414, air train 416, ferry 418, taxi 420, driving 422 and walking 424 modes of transport. The user can further specify user preferences with respect to walking distance 426, walking speed 428 and speed preferences, such as, average 430, fast 432 and slow 434 walking speeds. User selection options also include, without limitation, the option to specify multiple locations 438, mobility requirements 440 and time constraint 442.

The search engine further considers the route cost 444. A route is discarded over another route if the first route exceeds a predetermined cost. The algorithm determines the cost preferably by considering the proximity 446 of the travel, cost schedules 448, time of the day 450, travel distance 452, travel time 454 and travel expense 456.

The searching algorithm also considers the available schedules 458 of the travel. The schedules 458 are preferably driven dynamically by the current traffic conditions. Scheduling criteria such as weekday 460, weekend 462, peak 464, off-peak 466, late night 468, service interruptions 470, service frequency 472 and holidays 474 are preferably taken into account by the algorithm.

The searching algorithm also utilizes artificial intelligence 476 while finding route directions. The algorithm is directed by artificial intelligence that works with heuristic approaches. The artificial intelligence takes local practices 478, efficient routes 480, frequent ride benefit 482, rider comfort 484, and personal safety 486 into account for deciding travel directions. The artificial intelligence 476 accelerates decision-making and minimizes the need for repeated search computations.

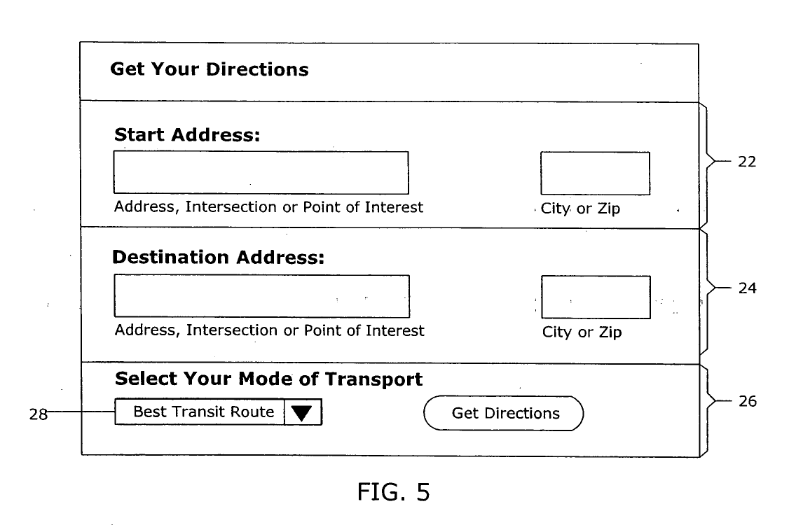

Referring to FIG. 5, a form 20 for entering the input of the route finding system of the present invention includes a first field 22, a second field 24 and a third field 26. Each of the first field 22 and the second field 24 includes at least two data entry fields for receiving location address data. Details of address data, such as building number, street name, landmark name and other address data, are preferably entered in a first data entry field. The name of the city or zip code of the city is preferably entered in a second data entry field. The third entry field includes a dropdown list 28 of preferred modes of transport from which a desired mode is selectable. Preferably, a user has the option of saving user travel preferences into the database layer for future access and streamlining of the routes finding method.

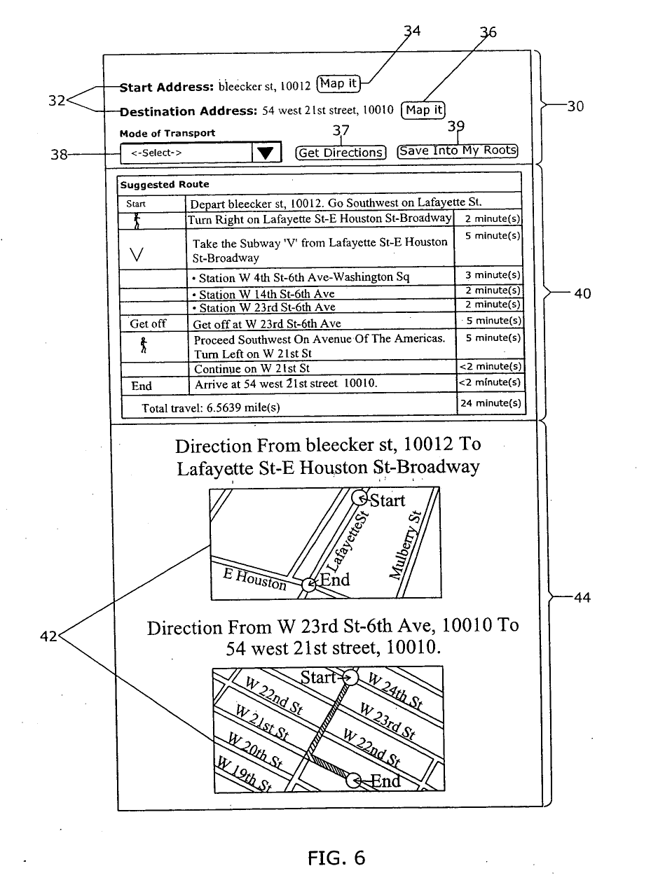

Referring to FIG. 6, a layout of a form 30 that displays detailed route directions and route maps is shown. The form 30 had a plurality of frames. A first frame 32 on the top end portion of form 30 includes the start address and destination address as entered by the user and then verified by the software program of the route finding system. The first frame 32 also includes a pair of user selectable mapping buttons, for example, virtual push buttons. A first button 34 is placed besides the start address and a second button 36 is positioned besides the destination address. The bottom end portion of the first frame 32 includes a drop down list 38 having a plurality of modes of transport and a get directions push button 37. The first frame 32 also features a save into my roots push button 39.

A second frame 40 preferably includes a suggested optimal route, having a plurality of segments displayed in sequential steps. The second frame 40 includes the detailed information of each of the route segments, such as mode of transport, travel time, fare, transfer and other travel details. The optimal route directions suggested in the second frame 40 are displayed with maps 42 at the bottom end portion of a third frame 44.

The route directions and the related maps 42 are preferably displayed by two display methods. The first method of display of maps is preferably employed where the suggested route includes information about available public modes of transport, for example, air, railway or bus modes. The second method of display of maps is employed where private transport, for example, a private taxi or a personal car is preferred over public transport.

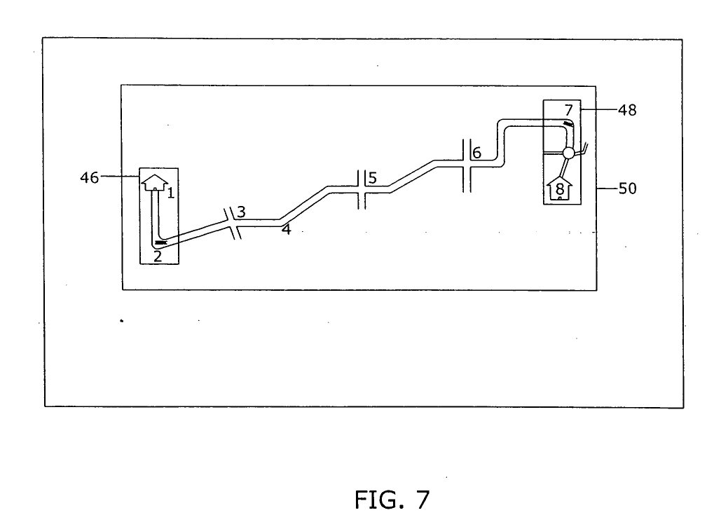

Referring to FIG. 7, FIG. 7 is representative of an optimal route map for an entire route, from a starting point to destination. In FIG. 7, the number ‘1’ indicates a starting point, ‘8’ indicates a destination point, ‘2’ indicates a first point of interest that is a nearest bus stop or a railway station from ‘1’. The number ‘7’ indicates a second point of interest that is a nearest bus stop or a railway station from the destination ‘8’, and points 3 through 8 indicate intermediate points between the first and second points of interest 2 and 7.

In the first display method, the route ‘1-8’ is divided into at least three segments and third frame 44 displays the maps 46 and 48 that has route segments 1-2 and 7-8. A first map 46 preferably shows details of the route segment ‘1-2’ and the second map 48 shows the details of route segment ‘7-8’.

In the second method, the route ‘1-8’ has at least one segment. The suggested route is preferably covered with either single modes of transit such as subway, car, taxi or with a combination of modes of transport in accordance with the route suggested. In the second method, the third frame 44 includes a single map 50 that shows a complete route form the origin 1 to the destination 8.

The route finding system of the preferred embodiment of the present invention, preferably, also includes a traffic alert system, a location based address finder, a local guidance tool and a tool for finding online travel booking for public and private transportation services. The traffic alert system displays the latest traffic updates for the roads in the city of the location of interest in a predefined sequence. The traffic alerts are created, preferably, with the input from the GPS. The location based address finder maps an address in the coverage area with the help of an address finder. The address finder also displays nearby points of interest such as bus stops, train stations, subway stations, and other points of interest, if desired.

The local guide tool is controlled by a software program that gives details of local interests or business in a coverage area. The local guide searches local interests, business, facilities and other local interests based in a municipality. The input to the local guide includes a description of the interest and name of the municipality or zip code of the municipality. The output is the detailed listing of the relevant interests, including the name, address, map and website of the each of the interest. For example, if the input is Universities in New York City then the local guide displays the listing of Universities in the New York City. The output also includes other details such as the mapped location of the points of interest.

In operation, the user selects a desired location and enters the route finding system. Then the user simply enters a start address and a destination address and chooses the mode of transport to get the routes. The mode of transport is selectable from a list that includes a plurality of transport modes such as driving, bus, subway, train, bus and subway, bus and train, subway and train, walking not more than 2 miles and the most efficient transit route. If the user ignores the mode of transport, the algorithm picks the most efficient mode of travel by default.

The user preferably inputs the start address, destination address and mode of transport through a Geographical Information System (GIS) interface via a suitable user interface, including without limitation, computer equipment, information technology equipment, and wired and wireless fixed and mobile telecommunications equipment. Cellular or mobile telephones, wireline telephones, computer desktops, laptops, hand-held computers, information kiosks, PDAs are but a few examples of such suitable interfaces. The results may be given back to the user through the same interface on which the input is entered. The system verifies the addresses entered by the user. In order to minimize erroneous user input, the system preferably recommends a plurality of addresses from the database to the user, if the addresses entered by the user are not identical to, but are close to the address in the database.

After user confirmation of the addresses the routes finding system recommends a transit route that uses modes of transit as per the user's choice and preferences. The map(s) of the route direction are also displayed at the bottom of the recommended routes. Optionally, the user can separately map the start address and destination address for better understanding of the routes.

Once the multimodal transit route is recommended based on user preferences, the recommended route is preferably divided into a plurality of route segments. Different modes of transit may be recommended for each route segment. For example, the system and method may recommend a taxi and provide a facility online to book a taxi for any walking distance that is more than, in the preferred embodiment, two miles segment of the transit route. The user can find a plurality of route direction for the same start address and the destination address by selecting different transit modes.

The user may be registered as a user of the system and may save their route directions and preferences for future travel decision-making using the system and method. A user may register as a user of the system by providing certain personal information such as name and address, and other personal information. The system is capable of providing a user id and password to the user after registration. The registered user can save his addresses, routes, maps, itinerary, and other user preference information, into the user's profile with the system. The user can then later recall preference and profile information, compare different routes, and obtain a better understanding of the most efficient route attainable using the route finding system.

The route finding system is also useable as an itinerary planner. The system can be used as an automobile navigating system to position a user on a road of interest. The sky routes tool suggest a plurality of options for air travel between two locations based on user-defined constraints and preferences.

While the invention has been described in detail and with reference to specific embodiments, it will be apparent to once skilled in the art that various changes and modifications can be made therein without departing from the spirit and scope of the invention. Thus, it is intended that the present invention cover the modifications and variations of this invention within the scope of the appended claims and their equivalents.

1) A real time method for finding multimodal route directions through user preferred modes of transport with a computer software program, comprising the steps of:
(a) receiving a start address and a destination address;
(b) receiving user preference criteria of at least one or more modes of transport from a list of modes of transport;
(c) verifying the start address and the destination address;
(d) searching the transit route directions;
(e) Comparing route directions for different transport modes; and
(f) displaying the transit route directions;

2) The method of claim 1, wherein the list of transport modes includes mode of transport, public transport modes, private transport modes and combinations of public and private transport modes.

3) The method of claim 2, wherein the mode of transport finds route directions with which distance between the starting address and the destination address is coverable in shortest time, lowest cost and with use of minimum modes of transport.

4) Method of claim 1, wherein the step of searching the transit route directions include steps of:
(a) searching a first point of interest;
(b) searching a second point of interest;
(c) searching matching routes between the first point of interest and the second point of interest.

5) The method of claim 4, wherein the first point of interest is a nearest public transport mode to the start address.

6) The method of claim 4, wherein the second point of interest is the nearest public transport mode to the destination address.

7) The method of claim 4, wherein the transit route directions includes at least three route segments, a first route segment having a route from the start address to the first point of interest, a second segment having a route from the first point of interest to the second point of interest, and the third segment having a route from the second point of interest to the destination address.

8) The method of claim 7, wherein the second route segment includes a plurality of root segments connected through intermediate points.

9) The method of claim 1, wherein the first method of displaying the transit route directions includes displaying at least two maps, a first map includes travel direction from the start address to a nearest location of public transport mode, and a second map includes travel direction from the destination address to a nearest location of a public transport mode for better user understanding of the route directions.

10) The method of claim 1, wherein the second method of displaying the transit route directions includes displaying at least one map with travel directions from the start address to the destination address for the travel with a private vehicle.

11) The method of claim 1, further comprising the step of creating a database.

12) The method of claim 11, wherein searching and creating the database is an iterative process.

13) A computer program product fixed in a tangible medium embodying a method for finding multimodal route directions through user preferred modes of transport, said method comprising the steps of:
(a) receiving a start address and a destination address;
(b) receiving user preference criteria of at least one or more modes of transport from a list of modes of transport;
(c) verifying the start address and the destination address;
(d) searching the transit route directions;
(e) comparing route directions for different transport modes; and
(f) displaying the transit route directions.

14) The computer program product of claim 1, further comprising the step of creating a database.

15) The computer program product of claim 11, wherein searching and creating the database is an iterative process.

16) In a network of computing devices, a system for finding multimodal route directions through user preferred modes of transport, comprising:
(a) a computing device, comprising a processor, a memory connected to the processor and an interface connected to the processor;
(b) the memory includes a set of instructions that, when executed, cause the processor to perform at least one or more of the following steps regardless of order:
(i) receiving a start address and a destination address;
(ii) receiving user preference criteria of at least one or more modes of transport from a list of modes of transport;
(iii) verifying the start address and the destination address;
(iv) searching for transit route directions based on the user preference criteria;
(v) comparing route directions for two or more transport modes; and
(vi) displaying the transit route directions based on the user preference criteria;

17) The system of claim 16, further comprising an instruction in the memory of least one or more computing devices that, when executed, cause the processor to perform the step of creating a database.

18) The system of claim 17, wherein searching and creating the database is an iterative process.

19) In a network of computing devices, a system for finding multimodal route directions through user preferred modes of transport, comprising:
(a) a computing device, comprising a processor, a memory connected to the processor and an interface connected to the processor;
(b) the memory includes a set of instructions that, when executed, cause the processor to perform at least one or more of the following steps regardless of order:
(i) means for receiving a start address and a destination address;
(ii) means for receiving user preference criteria of at least one or more modes of transport from a list of modes of transport;
(iii) means for verifying the start address and the destination address;
(iv) means for creating a database;
(v) means for searching for transit route directions based on the user preference criteria;
(vi) means for comparing route directions for two or more transport modes; and
(vii) means for displaying the transit route directions based on the user preference criteria;

20) The system of claim 19, wherein the means for searching and creating the database is an iterative process.
